(19) United States
(12) Patent Application Publication
(10) Pub. No.: US 2013/0133295 A1
(43) Pub. Date: May 30, 2013

(54) Polymer Sheet with Improved Barrier Properties

(71) Applicants: Bakhtiar Alam Shah, Tinley Park, IL (US); Glenn Lee VanDerWende, New Hope, PA (US); Nitya Prakash Khasat, Newark, DE (US); Michael Charles Restaino, Birmingham, MI (US)

(72) Inventors: Bakhtiar Alam Shah, Tinley Park, IL (US); Glenn Lee VanDerWende, New Hope, PA (US); Nitya Prakash Khasat, Newark, DE (US); Michael Charles Restaino, Birmingham, MI (US)

(21) Appl. No.: 13/304,353

(22) Filed: Nov. 24, 2011

(51) Int. Cl. C08L 23/12; B65B 1/04; B32B 27/08; C08K 3/26; C08K 3/34

(52) U.S. Cl. 53/473; 524/427; 428/476.9; 428/516; 428/412

(57) ABSTRACT

A polymeric sheet structure for use in a packaging container. The sheet contains a first layer of oxygen barrier material and a second and optionally third protective layer bonded to the first layer. The oxygen barrier layer material can be saponified ethylene-vinyl acetate copolymer, polyamide, polyvinyl alcohol, modification products thereof, or mixtures thereof, and the second and third protective layer can contain a polymer and an inorganic filler with an aspect ratio distribution in an amount sufficient to further enhance the moisture barrier property of the outer protective layer over what it would be in the absence of the filler. Also a process for protecting an oxygen or moisture sensitive material that includes the step of enclosing the material in a container that is completely or partially constructed of the sheet structure.

### FIELD OF THE INVENTION

This invention relates to a sheet structure useful for packages, and more particularly relates to a structure which is maintaining a high barrier in the presence of a high humidity environment such as a retort.

### BACKGROUND OF THE INVENTION

Oxygen barrier resins such as saponified ethylene-vinyl acetate copolymer (hereinafter referred to as “EVOH”) have low oxygen permeability and yet can be adversely affected by high humidity and are liable to undergo an increase of oxygen permeability under a highly humid atmosphere. Generally, packaging structures are adapted to retain their oxygen barrier property by including a protective layer, such as of a polyolefin or some other barrier polymer having a low water absorption or low moisture absorption on a layer of an oxygen barrier resin of high humidity dependency thereby precluding direct exposure of the oxygen barrier layer to water or moisture.

The dependence of the performance of a packaging structure on humidity is an important property because packages are used to store mammal foodstuffs, generally for humans or pets. Often packages are subjected to a “retort process” in which the molded package/container is subjected to excessive moisture as steam and at elevated temperatures typically around 250° F. (around 130° C.) and the ingress of moisture through the outer protective layers exponentially increases with temperature. This effect leads to lowering of the efficiency of EVOH as the barrier, an effect called “retort shock.” Although this lowering is almost a reversible process and the barrier efficiency generally returns to almost its pre shock value, in order to meet the expectations of the shelf life for the food contained in the retorted container the thickness of the EVOH barrier layer must be increased, or lower ethylene mole percent EVOH must be used. These are both expensive alternatives and the most economical way to ensure shelf life is still to protect the EVOH layer from the moisture/steam.

The protective layer can also be modified in order to increase resistance to retort shock. For example, U.S. Pat. No. 4,842,951 discloses a structure said to have improved barrier properties. A gas permeation-resistant resin layer has on both surfaces polyolefin based resin layers containing a specific inorganic filler, limited to talc or calcium carbonate. The structure also contains adhesive layers and further polyolefin based resin layers containing substantially no inorganic filler on both surfaces of layers. U.S. Pat. No. 6,846,533 discloses a container base with improved impact properties. The base is made from a mixture of a polyolefin and a filler. A high aspect ratio filler and a low aspect ratio filler are included in the filler. The filler comprises at least 50 wt. % of low aspect ratio filler.

There remains a need, however, for barrier materials with even better barrier performance, and in particular water vapor barrier. As a result of research into the next generation of moisture and oxygen barrier structures, the present inventors have made the unexpected discovery that addition of certain combinations of fillers with particular sizes, aspect ratios and relationships among these properties in an effective level to a protective layer, results in an even more improved moisture vapor barrier and faster recovery of the oxygen barrier property of a packaging structure from moisture after retort shock.

### SUMMARY OF THE INVENTION

The present invention is directed to a moisture barrier sheet structure comprising a mixture of a polymer and one or more mineral fillers, the mixture comprising from 10 to 75 of total weight % total filler and from 25 to 90 of total weight % polymer. The one or more fillers in total comprise an aspect ratio distribution such that the distribution arises from at least two sets of particles. A first set of particles has a high number average aspect ratio and a second set of particles has a low number aspect ratio. In one embodiment the set of high aspect ratio filler particles has a number average aspect ratio of at least 5:1 and the set of low aspect ratio filler particles has a number average aspect ratio of less than 3:1. The filler in total comprises less than 40 weight % of low aspect ratio filler particles.

In the above embodiment of the invention, the high aspect ratio particles in total have a median size in the range of 2 microns to 30 microns and the low aspect ratio particles have a median size in the range of 0.5 microns to 4 microns where size is determined by a sedimentation method or technique. In a further embodiment, the high aspect ratio particles have a median size of between 3 and 10 microns. The low aspect ratio particles may have a median size of between 0.5 and 2 microns.

The high aspect ratio particles and the low aspect ratio particles may be of different chemical compositions (for example and without limitation talc and calcium carbonate respectively) or they may be of the same chemical composition but derived from different and distinct filler populations, for example during compounding and formation of the mixture.

The mixture may also comprise a mixture of from 10% to 50% total filler or from 20 to 50% total filler, or even from 10% to 40% total filler or even from 20% to 40% total filler. In any event, the total filler population comprises less than or equal to 40 weight % of low aspect ratio filler particles.

The sheet structure may also have a water vapor transmission rate (WVTR) such that the WVTR of the structure is less than 40% of the WVTR of a structure made only with the polyolefin in the absence of filler particles, the WVTR being measured at 100% relative humidity and 23° C. (73° F.)

The first set of particles may further have a number average aspect ratio of from 5:1 to 40:1, from 10:1 to 20:1.

The second set of particles may have an aspect ratio of from 1:1 to 2:1.

The one or more fillers may comprise in total from 10 to 40 weight % low aspect ratio filler particles and from 60 to 90 weight % high aspect ratio filler particles.

The high aspect ratio filler particles may be without limitation of a filler selected from the group consisting of talc, mica, wollastonite, and combinations thereof. The low aspect ratio filler particles may be without limitation of a filler selected from the group consisting of calcium carbonate, barium sulfate, calcium oxide and a combination thereof. The low aspect ratio fillers may also, without limitation intended, have a porous surface. This is thought by the inventors to assist in the desorption of moisture after retort shock.

The particular polymer of the invention is not particularly limited, and any polymer that is suitable for the end use application, in particular packaging, may be used. For example, the polymer may without limitation be a polyolefin, polyamide, or polystyrene. The polyolefin may be a polypropylene, a polyethylene, polybutene, polybutadiene, or combinations thereof. The polyolefin may be a block or random copolymer comprising propylene and polyethylene units.

The mixture of the invention may comprise from 30 to 65 weight % filler and from 35 to 70 weight % polyolefin. The filler may include a mixture of from 60 to 90 weight talc and from 10 to 40 weight % calcium carbonate.

The sheet may furthermore comprise a base made from a mixture of a polymer and a filler, wherein the filler includes a mixture of from 60 to 90 weight % of a first filler and from 10 to 40 weight % of a second filler, the first filler being selected from talc, mica, wollastonite, or combinations thereof, and the second filler being selected from calcium carbonate, barium sulfate, or combinations thereof.

The invention is also directed to a multilayer sheet structure for use in a packaging container, said structure comprising:
(i) a first layer of oxygen barrier material having a first surface and an opposing second surface,
(ii) a protective second layer having a surface that is bonded to at least a portion of the first surface of the first layer in a face to face relationship, and;
(iii) a protective third layer having a surface that is bonded to at least a portion of the second surface of the first layer in a face to face relationship,

The oxygen barrier layer material is selected from the group consisting of saponified ethylene-vinyl acetate copolymer, polyamide, polyvinyl alcohol, and mixtures of the foregoing. The protective second and third layers comprise a moisture barrier polymer sheet as described above.

The second layer or the third layer may further comprise a skin layer adjacent to the surfaces of the second layer or third layer that are opposite to the first layer. Any of the skin layers may further comprise a polyolefin, and the skin layer or layers may be pigmented.

The second layer, the third layer or both may further be bonded to the oxygen barrier (first) layer by an intermediate layer that comprises a polymeric adhesive suitable to bond the first layer to the second and/or third layers. The intermediate polymer layer may without limitation comprise a functionalized homopolymer or copolymer of polyethylene or polypropylene achieved by polymerization or grating with maleic anhydride.

The filler particles further may further comprise a surface coating over at least a portion of their surface.

The invention is further directed to a container that comprises a structure according to any of the embodiments described above. For example a container comprising walls in which the walls comprise a multilayered polymeric structure. The structure comprises a first layer of oxygen barrier material and second and third protective layers bonded to the first layer on either side of the first layer where the protective layers are the sheet layer as described above.

The invention is further directed to a process for protecting an oxygen or moisture sensitive material comprising the steps of providing an oxygen or moisture sensitive material, enclosing the material in a container, wherein the container comprises a structure according to any of the sheet structure or the multilayer sheet structure described above.

The process of the invention is also directed to a process for protecting an oxygen or moisture sensitive material comprising the steps of providing an oxygen or moisture sensitive material, enclosing the material in a container, wherein the container walls, lid or both are partially or totally constructed of a structure according to any of the sheet structure or the multilayer sheet structure described above.

### BRIEF DESCRIPTION OF THE FIGURES

FIG. 1 shows a plot of oxygen transmission rate after retorting for samples prepared according to the invention, and control samples.

### DETAILED DESCRIPTION OF THE INVENTION

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When the word “about” is used as a qualifier for the end point of the range, then the end point is also to be considered as disclosed herein. When the term “comprising” is used to leave open the totality of the composition or structure of an item, this term is also intended to include a disclosure or claim to an embodiment that consists of that totality.

The invention is also directed to a moisture barrier sheet structure or a laminated multilayer sheet structure that is suitable for protective packaging. By “sheet structure” is meant herein that the structure has two dimensions that are significantly larger than a third, thickness, dimension such that two opposing surfaces of the structure defined by the larger dimensions can be identified.

One embodiment of the sheet structure of the invention comprises a mixture of a polymer and one or more mineral fillers, the mixture comprising from 10 to 75 of total weight % total filler and from 25 to 90 of total weight % polymer. The one or more fillers in total comprise an aspect ratio distribution such that the distribution arises from at least two sets of particles. A first set of particles has a high number average aspect ratio and a second set of particles has a low number average aspect ratio. The set of high aspect ratio filler particles has a number average aspect ratio of at least 5:1 and the set of low aspect ratio filler particles has a number average aspect ratio of less than 3:1. The filler in total comprises less than 40 weight % of low aspect ratio filler particles.

By “one or more mineral fillers” is meant one or more filler type or chemical composition. For example mica and calcium carbonate would be considered different types or chemical composition. The filler types may also be of the same chemical composition but arise from distinct populations of particles, for example during compounding or manufacture of the sheet structure. Each set of particles consists of a separate type or population of filler particles that may be further characterized by its number average aspect ratio. The term “aspect ratio” of a particle is defined herein as the ratio of a largest dimension of the particle divided by a smallest dimension of the particle. When a particle is flat or in the form of a platelet, the aspect ratio is defined as the ratio of the mean of the two largest dimensions of the particle divided by the thickness of the platelet. The aspect ratios are determined by scanning under an electron microscope (for example, 2,000 times magnified) and visually viewing the outside surfaces of the particles to determine the lengths and thicknesses of the particles.

The aspect ratio of the totality of filler particles in the structure of the invention may be bimodal. By a “bimodal distribution” in the context of aspect ratio of the total population of filler particles is meant that a plot of number of occurrences of any particular range of aspect ratio versus the aspect ratio for the total filler population shows two populations of aspect ratio, one a high aspect ratio and one a lower aspect ratio than the first. The plot may therefore have two peaks, that are not limited in any way in breadth and the peaks may partially overlap or be separate.

The terms “number average” and “mean” as used herein are synonymous. In one embodiment of the invention a high aspect ratio filler particle may have an aspect ratio of at least 5:1. The high aspect ratio filler particles in total of the present invention may all have an aspect ratio in the range of from 5:1 to 40:1, and preferably from 5:1 to 20:1, or even 10:1 to 20:1. The high aspect ratio fillers of the present invention may also without limitation have a number average aspect ratio of from 5:1 to 40:1, and preferably from 5:1 to 20:1, or even 10:1 to 20:1. The high aspect filler may be, for example that is not intended to be limiting, talc, mica, wollastonite, or combinations thereof. Commercially available talc materials include JETFIL® 575, available from Luzenac America of Englewood, Colo. Commercially available mica materials include SUZOREX® 325-PP, available from Zemex Industrial Minerals, Inc. Commercially available wollastonite include the NYGLOS® series of wollastonite, available from NYCO Minerals Inc. of Calgary, Alberta, Canada.

The term “size” as used herein is synonymous with “diameter” where the diameter is defined as that diameter, commonly known as the “Stokes” diameter, as measured by a sedimentation technique as described below. The high aspect ratio fillers used in the present invention preferably have a median diameter established by a sedimentation method of between 2 microns and 30 microns, and more preferably from 3 microns to 10 microns or even greater than 4 microns to 10 microns. The low aspect ratio fillers have preferably a median diameter of from 0.5 to 4 microns, more preferably 0.5 to 2 microns. The diameter of particles is measured by a sedimentation technique. Sedimentation analysis is based upon Stokes' Law and provides a method for determining particle size distribution (PSD). A single solid (or nonporous) sphere settling in a fluid has a terminal settling velocity which is uniquely related to its diameter. In a non-limiting example of the method for measuring particle size distribution, the SediGraph determines particle size distributions using the sedimentation method by measuring the gravity-induced settling velocities of different size particles in a liquid with known properties, the particle sizes are determined. The rate at which nonporous particles fall through a liquid is described by Stokes' Law as:

Dₛₜ={18 μV/g(ρ_{S}−ρ₁)}^{0.5}

where
Dₛₜ=Stokes' diameter
μ=fluid viscosity
ρₛ=density of the solid
ρ₁=density of the liquid
V=settling velocity
g=acceleration due to gravity

One skilled in the art will understand how to prepare the sample of any particular filler for the sedimentation method and interpret the result taking into account the effects of particle porosity or asymmetry.

The low aspect ratio filler may, in a non limiting example, be calcium carbonate, barium sulfate, calcium oxide, or any combination thereof. Commercially available calcium carbonate includes OMYACARB FT®, available from OMYA Inc. of Alpharetta, Ga. One example of commercially available barium sulfate is BARITE 2075®, available from Polar Minerals in Mentor, Ohio. A low aspect ratio filler particle may without limitation be a filler having an aspect ratio in the range of less than or equal to 3:1, preferably less than or equal to 2:1. The low aspect ratio filler particles in total may also without limitation have a number average aspect ratio in the range of less than or equal to 3:1, preferably less than or equal to 2:1.

The filler mixture of the present invention comprises less than 40 weight % low aspect ratio filler. The filler mixture may also in one embodiment be from 5 to 40 weight % low aspect ratio filler and from 60 to 95 weight % high aspect ratio filler.

In one embodiment of the invention, the high aspect ratio particles all have a size in the range of 2 microns to 30 microns and the low aspect ratio particles have a size in the range of 0.5 microns to 4 microns. In a further embodiment, the high aspect ratio particles have a median size of between 3 and 10 microns and the low aspect ratio particles have a median size of between 0.5 and 2 microns.

The terms “multilayer sheet structure” and “multilayer barrier structure” and “multilayer barrier material” and “multilayer structure” as used herein are synonymous. In one embodiment the present invention comprises an oxygen barrier layer in contact with and bonded in face to face contact to at least one protective layer. The protective layer is any of the embodiments of a moisture barrier sheet structure with improved barrier properties described above.

In one embodiment the present invention comprises an oxygen barrier layer in contact with and bonded in face to face contact to at least one protective layer over a portion or all of their surfaces. By “face to face” is meant that one surface of one layer is in contact over at least a portion, and even over all, of the surface with one surface of a second layer. The protective layer of the invention is of the same composition as the sheet structure described above.

When used as packaging, the multilayer structure will typically have a thickness in the range 0.1 to 10 mm, preferably 0.1 to 5 mm and more preferably 0.1 to 2 mm.

In the two layer embodiment the multilayer sheet structure comprises an oxygen barrier layer and a protective layer. In a three layer embodiment, for example, the multilayer structure comprises an oxygen barrier layer sandwiched between two protective layers. The bonding of the oxygen barrier layer and the protective layer or layers can be enabled by use of one or more adhesive layers located in between the layers to be bonded. The protective layers may each also be in contact with a further skin layer. The skin layers serve to provide a desired surface appearance to the multilayer, or to provide a substrate for any desired pigmentation. Each layer of the multilayer structure will be described in more detail below.

The multilayer structure of the invention can be made by any technology known to one skilled in the art. For example, and without limitation, co-extrusion, co-injection molding, or extrusion blow molding are processes that can be used to fabricate the structure of the invention. The structure of the invention may also be made by lamination of multiple separate sheets.

In a preferred embodiment, the invention is directed to a multilayered sheet structure for use in a packaging container, said structure comprising:
(i) a first layer of oxygen barrier material having a first surface and an opposing second surface,
(ii) a protective second layer having a surface that is bonded to at least a portion of the first surface of the first layer in a face to face relationship, and;
(iii) a protective third layer having a surface that is bonded to at least a portion of the second surface of the first layer in a face to face relationship,

The oxygen barrier layer material is selected from the group consisting of saponified ethylene-vinyl acetate copolymer, polyamide, polyvinyl alcohol, and mixtures of the foregoing. The second and third protective layers comprise a moisture barrier polymer and either one or both of the protective layers comprise inorganic filler particles dispersed in the moisture barrier polymer according to the sheet structure with improved barrier properties described above.

The multilayer structure of the invention shows enhancement in the rate of recovery of the oxygen transmission rate (OTR) of the structure over what it would be in the absence of the filler particles after a retort shock. “Retort shock”, as used here, is a process whereby the structure is subjected to moisture vapor in the form of steam at a temperature of at least 125° C. for typically 15 to 70 minutes impinging on the one or both of the filled protective layers. As claimed herein, retorting takes place for 33 minutes at 12° C.

The rate of recovery of OTR may be measured directly and OTR at two different times after retort shock compared. Alternatively, the rate of recovery of OTR can measured by the integral of a plot of oxygen transmission rate versus time where time is measured from the end of the retorting process for 50 hours and enhancement means that the integral in the presence of particles is less than that in the absence of particles.

The structure of the invention shows an enhancement of the rate of recovery of the oxygen transmission rate of the structure after a retort shock over what the recovery rate would be in the absence of the filler particles in the one or more protective layers.

### Oxygen Barrier Layer

Examples of the material for this layer include saponified ethylene-vinyl acetate copolymers, polyamides, polyvinyl alcohol, modification products and mixtures thereof. Among the materials enumerated above, the saponified ethylene-vinyl acetate copolymer having an ethylene content in the range of 25 to 50 mol % and a saponification degree of not less than 96% is a preferred embodiment. By increasing the ethylene content beyond 25 mol %, the molding properties, for example in extrusion molding and blow molding, are improved. By holding down the ethylene content below 50 mol %, the oxygen barrier property is enhanced.

The oxygen barrier layer can also be made of multiple extruded layers of the same or different barrier materials. In an example of this structure, the barrier layer will be extruded from a multilayer die and the resulting extrudate bonded into a single layer, preferably by application of pressure and heat.

### Protective Layers

Examples of the material use in the construction of these layers include homo and copolymers from the family of polypropylene resins, polystyrene and rubber modified polystyrene, linear and branched polyethylenes regardless of the resin density (for example high-density of density above 0.94, medium-density polyethylene of density above 0.92 to 0.94, and low-density and linear low density polyethylene of density 0.92 and below), polyethylene terephthalate, polybutylene terephthalate, polycarbonates, acrylonitrile-styrene-butadiene copolymer, modification products and mixtures thereof. The polymer used for the protective layer is not limited, however, and, for example, nylon (polyamide) can also be used in this application. In one embodiment the material of construction of the protective layer or layers is a random or block copolymer of ethylene and propylene.

If there is more than one protective layer in the structure, then at least one of the protective layers is a moisture barrier sheet structure as described above and has filler particles incorporated therein as described above, and dispersed in the polymer, in an amount effective to increase the moisture barrier property of the layer or to reduce the oxygen transmission rate of the first layer after moisture exposure when compared to a structure that has no filler particles. For example, in a two layer structure, the protective layer will have filler incorporated therein. In a three layer structure as described above, one or both of the protective layers will have filler incorporated therein.

In certain embodiments, the weight percentage of the high aspect ratio particles by weight of total particles can be at least 60% or even at least 80%.

Further, it is possible to add to the polymer composition in any layer of the structure of the invention appropriate amounts of various additives, such as antioxidants, weathering agents, antistatic agents, foaming agents, colorants, and the like.

The method of preparing the polymer plus filler composition of the present invention is not particularly restricted. Kneading machines commonly employed for plastics or rubbers, such as a Banbury mixer, a single-screw extruder, a twin-screw extruder, a roll mill, Farrel continuous mixer, etc., can be used. The resulting blended composition can be molded into desired molded products by thermoforming extruded sheet or film, injection molding, extrusion molding, blow molding, etc. in a manner known to one skilled in the art. Filler can be compounded in the carrier resin off or in line with the sheet extrusion process.

The filler of the protective barrier layer for the invention is a blend of a high aspect ratio filler and a low aspect ratio filler. The two fillers may be of the same chemical composition or of different compositions. As mentioned above, the term “aspect ratio” of a three dimensional particle is defined herein as a ratio of a largest dimension of the particle divided by a smallest dimension of the particle. When a particle is flat or in the form of a platelet, the aspect ratio is defined as the average of the two largest dimensions of the particle divided by the thickness of the platelet. The aspect ratios can be determined by scanning under an electron microscope and visually viewing the outside surfaces of the particles to determine the lengths and thicknesses of the particles. The use of single digits and the use of two digits to describe aspect ratio herein are synonymous. For example the terms “5:1” and “5” both have the same meaning. A low aspect ratio filler is defined as being a filler having an aspect ratio of from 1:1 to 3:1 and such fillers can also be used in the structure of the invention. Examples of low aspect ratio fillers may include calcium carbonate, barium sulfate, or combinations thereof. Commercially available calcium carbonate includes OMYACARB FT®, available from OMYA Inc. of Alpharetta, Ga. One example of commercially available barium sulfate is BARITE 2075®, available from Polar Minerals in Mentor, Ohio.

The high aspect ratio filler particles may individually all further have an aspect ratio of between 5 and 120 or 10 and 120, or even between 5 and 40 or 10 and 40. The number average aspect ratio of the low aspect ratio filler particles may be between 1 and 3 or 1 and 2. In a further embodiment at least 10% and preferably at least 30% of the filler particles are of low aspect ratio.

The filled polymer layer of the structure may be formed by direct compounding and extrusion of a polymer with particulate mineral filler, for example, using a twin screw extruder. Irrespective of the method used to incorporate the filler into the polymer, other examples of particulate mineral fillers that may be used include, but are not limited to, talc, calcium carbonate, calcium oxide, silica, barium sulfate, wollastonite (Ca₃(Si₃O₉)), mica, clay, kaolin or combinations thereof. For example, the protective layer may comprise calcium carbonate, talc, and polypropylene, where the weight percentage of calcium carbonate is 40% or less than the total weight of filler.

Commercially available wollastonite may be obtained from NYCO, Calgary, Alberta, Canada. Commercially available mica materials include ALBASHIELD® 15, available from Zemex Industrial Minerals, Inc.

It is contemplated that other additives may be added to the protective layer or layers if used. For example, titanium dioxide (TiO₂) may be added the polymer layer to provide a whitening effect. Other additives, such as other pigments, may be added to the substrate. The layer may also include recycled material, either post-consumer or manufacturing scrap, for example.

Other examples of fillers to be used in the present invention are not particularly limited to the above, and include inorganic fillers, such as silica, diatomaceous earth, alumina, zinc white, magnesium oxide, calcium sulfite, calcium sulfate, calcium silicate, glass powders, glass fibers (inclusive of silane-treated glass fibers), asbestos, gypsum fibers, and the like.

These fillers may be used either individually or, if desired, in combination thereof. In view of a favorable balance between moisture resistance and other properties of the resulting composition, talc and/or mica are preferably used as high aspect ratio fillers.

The filler used in the invention may also be coated. In accordance with one aspect of the invention, surface treatment of the fillers, in particular those which are hydrophilic, includes reaction of the filler surface with organosilanes, modified oligomers and a wide variety of surfactants. Typically, the entire surface of the filler is treated with surfactant.

The high aspect ratio fillers used in the present invention preferably have a median size as measured by a sedimentation technique of between 2 microns and 30 microns, and more preferably from 3 microns to 10 microns. The low aspect ratio fillers have preferably a median size of from 0.5 to 4 microns, more preferably 0.5 to 2 microns.

In one embodiment of the multilayer sheet of the invention either or both of the protective layers will generally comprise over at least a part of their surfaces a pigmented skin that is between 0 to 25% of the thickness of the multilayer sheet. The skin is bonded to a protective

The pigmented skin is preferably a polyolefin or a blend of several polyolefins, the term “polyolefin” being as understood by one skilled in the polymer arts as being a polymer of an unsaturated hydrocarbon (olefin.) The pigmented skin contains pigment to provide the desired coloration for the multilayer surface, and one skilled in the art will be able to easily identify appropriate pigments for use in this application. At least one of the protective layers is filled as described in the barrier structure above and comprises a polymer, filler particles as described above, and optionally regrind or recycled materials. The container may be made by a thermoforming or molding process, but any process known to one skilled in the art will suffice to make the container.

### Adhesive Layer

This layer bonds the oxygen barrier layer to the protective layer or layers as described above. Examples of the material for this layer include polar group-containing modified polyolefins obtained by graft modifying polyethylene, polypropylene, or ethylene-vinyl acetate copolymer with unsaturated carboxylic acids, or unsaturated polycarboxylic acids or anhydrides thereof; ethylene-vinyl acetate copolymer and saponification products thereof; ethylene-ethylacrylate copolymer, ethylene-acrylic acid copolymer, ethylene-methacrylic acid copolymer, ionomers obtained by cross-linking such copolymers with metallic ions; and block copolymers of styrene with butadiene. These are preferably synthetic resins compatible with synthetic resins used for forming the oxygen barrier layer and the protective layers.

### Containers

The present invention is also directed to a container that is constructed using the multilayer sheet structure of the invention as described above as a wall of the container. A container will generally comprise a lid and a body, where the body is constructed of walls. The lid can be constructed of the multilayer barrier construction disclosed herein, or metal or any suitable barrier material. The body of the container comprises a wall or walls that are constructed according to the multilayer barrier material structure or structures described above.

For example, in one embodiment of the container of the invention the outside and inside walls of the container wall will generally comprise over at least a part of their surfaces a pigmented skin that is between 0 to 25% of the thickness of the container wall. The skin is bonded to a protective layer. At least one, and preferably both, of the protective layers in the container wall comprise filler or fillers as described above. The protective layers then comprise 5 to 40% of the thickness of the container.

An oxygen barrier layer, preferably EVOH, comprises 1 to 10% of the thickness of the container wall. Adhesive layers as described above bond the oxygen barrier layer to at least one and preferable two protective layer or layers. In this embodiment the adhesive layer constitutes 1 to 5% of the thickness of the container.

The pigmented skin is preferably a polyolefin or a blend of several polyolefins, the term “polyolefin” being as understood by one skilled in the polymer arts as being a polymer of an unsaturated hydrocarbon (olefin.) The pigmented skin contains pigment to provide the desired coloration for the multilayer surface, and one skilled in the art will be able to easily identify appropriate pigments for use in this application. At least one of the protective layers is filled as described in the barrier structure above and comprises a polymer, filler particles as described above, and optionally regrind or recycled materials. The container may be made by a thermoforming or molding process, but any process known to one skilled in the art will suffice to make the container.

The adhesive layer is preferably a functionalized extrudable thermoplastic resin, e.g., maleated or otherwise functionalized olefins. One skilled in the art will understand what resin may be used to compatibilize the oxygen barrier and the protective layer. In some cases mineral filler can be added to the outer skin layers or these layers can be eliminated.

The container of the invention can be manufactured by thermoforming of the multilayered barrier. Thermoforming of polyolefins, for example, is well known. Generally, a sheet of the polyolefin is formed or shaped by heating the sheet above the softening temperature of the polyolefin, fitting the sheet along the contours of a mold with pressure supplied by vacuum or other force, and removing the shaped article from the mold after cooling below its softening point.

Thermoforming methods such as pressure forming, vacuum forming, or plug-assist vacuum forming are often useful in packaging products. In general terms, thermoforming involves heating of a thermoplastic film or laminate and forming the film or laminate into a desired shape for holding a product to be inserted. This sheet of a film or laminate is usually referred to as a forming web. Various systems and devices are used in a thermoforming process, often accompanied by vacuum-assist and plug-assist components to provide the proper forming of the forming web into a predetermined shape.

A packaging container according to the present invention may therefore comprise a container formed by deforming a multilayer sheet as described above according to a thermoforming method, and a lid made of a resin or of a metal or of another suitable barrier material and adapted for sealing the holding container.

The container can also be formed by other methods, for example and not limited to, co-injection molding, extrusion blow molding, laminated sheet thermoforming, and any other method known to one skilled in the art.

### Method for Protecting Substances

The invention is also directed to a method for protecting an oxygen sensitive substance, such as a foodstuff, comprising the step of enclosing the material in a package. The package comprises a laminated multilayer sheet structure according to any of the embodiments that are described above, or a sheet structure as described above. For example in one embodiment the multilayer material comprises a first layer of oxygen barrier material and a second protective layer bonded to the first layer in a face to face relationship by one surface on each of the first layer and the protective layer.

The oxygen barrier layer material is selected from the group consisting of saponified ethylene-vinyl acetate copolymer, polyamide, polyvinyl alcohol, modification products thereof, and mixtures thereof, and the second protective layer comprises a protective polymer and an inorganic filler dispersed in the polymer in an amount sufficient to further enhance the rate of recovery of the multilayer sheet structure after retort shock as defined above. Enhancement means The OTR of the sheet structure recovers more quickly after retort shock in the presence of inorganic filler than in its absence.

The invention is also directed to a process for protecting an oxygen or moisture sensitive material comprising the steps of providing an oxygen or moisture sensitive material, enclosing the material in a container, wherein the container comprises a structure according to any of the sheet structure or the multilayer sheet structure claimed above.

The invention is also directed to a process for protecting an oxygen or moisture sensitive material comprising the steps of providing an oxygen or moisture sensitive material, enclosing the material in a container, wherein the container walls, lid or both are partially or totally constructed of a structure according to any of the sheet structure or the multilayer sheet structure claimed above.

### EXAMPLES

### Sample Composition

The calcium carbonate used in the examples was obtained from Heritage Plastics (Picayune, Miss.) and had a median particle size of 2 microns and a mean aspect ratio of 1:1.

The polypropylene was a virgin homopolymer of melt flow rate (MF) 4.0 using ASTM Test D-1238 with a weight of 2.16 kg at 230° C. The adhesive was a maleic anhydride grafted polypropylene. The EVOH used in this study was produced by Soarus (Arlington Heights, Ill.) A Talc masterbatch was obtained from Heritage Plastics (Sylacauga, Ala.) and was 40% talc and 20% Calcium carbonate compounded in polypropylene homo polymer. A control was 60% talc in PP homopolymer of melt flow rate 4.0. The specific talc used was Stellar 510 from Luzenac. Talc particle diameter in the examples herein was established using a Sedigraph 5120 instrument (Micromeritics, Norcross, Ga.) as specified by the talc supplier. Median particle size was 5 microns as measured by Sedigraph. Number average aspect ratio was 5:1. A control sample was also prepared that had no talc in the PP protective layers.

TABLE 1
Sample composition

| | Polypropylene | Talc | Calcium Carbonate |
|---|---|---|---|
| Sample | Weight % | Weight % | Weight % |
| Comparative 1 | 70 | 30 | 0 |
| Comparative 2 | 100 | 0 | 0 |
| Example 1 | 70 | 20 | 10 |
| Example 2 | 70 | 20 | 10 |

### Water Vapor Transmission Rate (WVTR.)

WVTR was measured using a Permatran-W 3/60 instrument (Mocon, Minn.), the WVTR being measured at 100% relative humidity and 23° C. (73° F.) Table 2 shows WVTR data from the samples tested.

TABLE 2
WVTR of Samples

| Sample | WVTR |
|---|---|
| Comparative 1 | 0.005 |
| Comparative 2 (duplicate samples) | 0.013 |
| Example 1 | 0.0036 |

Table 2 shows the unexpected result that the combination of low and high aspect ratio particles provide a higher water vapor barrier than any of the controls.

### Oxygen Transmission Rate (OTR)

Multilayer sheets of 0.045 inch (1.14 mm) thickness were extruded with following seven layer structure:
(i) Outer layer of virgin polypropylene (5% of thickness of sheet.)
(ii) Protective layer of polypropylene with the compositions of table 1, where comparative examples 1 and 2 and examples 1 and 2 were duplicates.
(iii) Maleic anhydride grafted PP adhesive (2% of thickness of sheet.)
(iv) EVOH (5% of thickness of the total sheet width.)
(v) Maleic anhydride grafted PP Adhesive (2% of thickness of sheet.)
(vi) Same as layer (ii)
(vii) Same as layer (i).

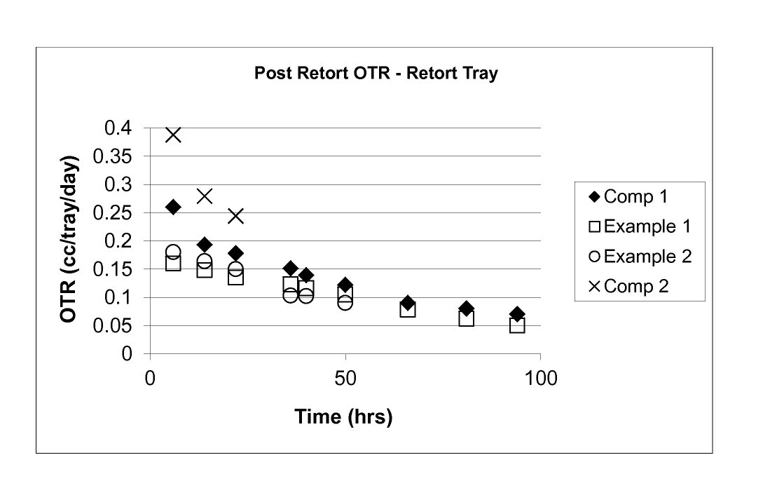

Oxygen transmission rate was measured on containers that were placed on a Mocon 2/21 (Mocon Inc., Minneapolis, Minn.) for 10 days according to ASTM F-1307, hereby incorporated in its entirety by reference. (Mocon Inc., Minneapolis, Minn.) FIG. 1 shows the results of the oxygen transmission rate (OTR) testing. The transmission rate in the filled sample of the invention has an OTR that is less than half that of the unfilled sample after retort, or steam treatment and recovers more quickly to a lower OTR than the unfilled sample. Similarly, the OTR of the samples of the invention show a reduction in transmission rate over even the comparative example with a single filler (comparative example 1.)

These results show the unexpected effectiveness of the filled samples of the invention at lowering OTR after resort shock.

We claim:

1. A sheet structure comprising a mixture of a polymer and one or more mineral fillers, the mixture comprising from 10 to 75 of total weight % total filler and from 25 to 90 of total weight % polymer, wherein the one or more mineral fillers in total comprises an aspect ratio distribution such that the distribution arises from at least two sets of particles, a first set of particles having a high number average aspect ratio and a second set of particles having a low number aspect ratio, the set of high aspect ratio filler particles having a number average aspect ratio of at least 5:1 and the set of low aspect ratio filler particles having a number average aspect ratio of less than or equal to 3:1, the filler in total comprising less than 40 weight % of low aspect ratio filler particles, and wherein the high aspect ratio particles have a median size in the range of 2 microns to 30 microns and the low aspect ratio particles have a median size in the range of 0.5 microns to 4 microns where particle size is measured by sedimentation.

2. The structure of claim 1 in which the water vapor transmission rate (WVTR) of the structure is less than 40% of the WVTR of a structure made only with the polyolefin in the absence of filler particles, the WVTR being measured at 100% relative humidity and 23° C. (73° F.)

3. The structure of claim 1, wherein the first set of particles has a number average aspect ratio of from 5:1 to 40:1.

4. The structure of claim 3, wherein the first set of particles has a number average aspect ratio of from 10:1 to 20:1.

5. The sheet of claim 1, wherein the second set of particles has a number average aspect ratio of less than or equal to 2:1.

6. The sheet of claim 1, wherein the one or more fillers comprise in total from 10 to 40 weight % low aspect ratio filler particles and from 60 to 90 weight % high aspect ratio filler particles.

7. The sheet of claim 1, wherein the high aspect ratio filler particles are a filler selected from the group consisting of talc, mica, wollastonite, and combinations thereof.

8. The sheet of claim 1 wherein the high aspect ratio particles have a median size of between 3 and 10 microns and the low aspect ratio particles have a median size of between 0.5 and 2 microns.

9. The sheet of claim 1, wherein the low aspect ratio filler particles are a filler selected form the group consisting of calcium carbonate, barium sulfate, and a combination thereof.

10. The sheet of claim 1 wherein the polymer is selected from the group consisting of a polyolefin, a polyamide, polystyrene, and blends thereof.

11. The sheet of claim 10, wherein the polyolefin is a polypropylene, a polyethylene, polybutadiene, polybutene, or combinations or copolymers thereof.

12. The sheet of claim 11, wherein the polyolefin is a polypropylene.

13. The sheet of claim 12, wherein the polyolefin is a polypropylene homopolymer.

14. The sheet of claim 12, wherein the polyolefin is a block or random copolymer comprising propylene and polyethylene units.

15. The sheet of claim 1, wherein the mixture comprises from 30 to 65 weight % filler and from 35 to 70 weight % polyolefin.

16. A sheet comprising a base made from a mixture of a polyolefin and a filler, wherein the filler includes a mixture of from 60 to 90 weight % of talc and from 10 to 40 weight % of calcium carbonate.

17. The sheet of claim 16, wherein the polyolefin is a polypropylene, a polyethylene, or combinations thereof.

18. The sheet of claim 17, wherein the polyolefin is a homopolymer polypropylene.

19. The sheet of claim 17, wherein the polyolefin is a block or random copolymer comprising propylene and polyethylene units.

20. A sheet comprising a base made from a mixture of a polymer and a filler, wherein the filler includes a mixture of from 60 to 90 weight % of a first filler and from 10 to 40 weight % of a second filler, the first filler being selected from talc, mica, wollastonite, or combinations thereof, and the second filler being selected from calcium carbonate, barium sulfate, or combinations thereof.

21. The sheet according to claim 20, wherein the first filler is talc.

22. The sheet according to claim 20, wherein the second filler is calcium carbonate.

23. A laminated multilayered sheet structure for use in a packaging container, said structure comprising;
(i) a first layer of oxygen barrier material having a first surface and an opposing second surface,
(ii) a protective second layer having a surface that is bonded to at least a portion of the first surface of the first layer in a face to face relationship, and;
(iii) a protective third layer having a surface that is bonded to at least a portion of the second surface of the first layer in a face to face relationship,
where the oxygen barrier layer material is selected from the group consisting of saponified ethylene-vinyl acetate copolymer, polyamide, polyvinyl alcohol, and mixtures of the foregoing, the protective second and third layers comprise a moisture barrier polymer, and either one or both of the protective layers comprise a mixture of mineral filler particles dispersed in the moisture barrier polymer the mixture comprising from 10 to 75 of total weight % total filler and from 25 to 90 of total weight % of a polymer, the one or more mineral fillers in total comprising an aspect ratio distribution such that the distribution arises from at least two sets of particles, a first set of particles having a high number average aspect ratio and a second set of particles having a low aspect ratio, the high aspect ratio filler particles having a number average aspect ratio of at least 5:1 and the low aspect ratio filler particles having an aspect ratio of less than 3:1, the filler in total comprising less than 40 weight % of low aspect ratio filler particles and wherein the high aspect ratio particles all have a median size in the range of 2 microns to 30 microns and the low aspect ratio particles have a median size in the range of 0.5 microns to 4 microns where particle size is measured by sedimentation.

24. The structure of claim 23 wherein the structure shows an enhancement of the rate of recovery of the oxygen transmission rate of the structure after a retort shock over what it would be in the absence of the filler particles and where retort shock is a process in which the structure is subjected to moisture vapor in the form of steam at a temperature of 125° C. for 33 minutes impinging on the one or both of the protective layers.

25. The structure of claim 23 in which the rate of recovery of oxygen transmission is measured by the integral of a plot of oxygen transmission rate versus time where time is measured from the end of the retorting process for at least 50 hours and enhancement means that the integral in the presence of particles is less than that in the absence of particles.

26. The structure of claim 23 in which the moisture barrier polymer in the second and third layers is independently selected from the group consisting of polypropylene, polystyrene, high-density polyethylene, medium-density polyethylene, low-density polyethylene, polyethylene terephthalate, polybutylene terephthalate, polycarbonates, acrylonitrile-styrene-butadiene copolymer, polyphenylene oxide, modification products and mixtures thereof.

27. The structure of claim 23 which further comprises a fourth and fifth adhesive layers in between the first and second, and first and third layers respectively.

28. The structure of claim 23 in which the second layer further comprises a skin layer bonded to the side of the second layer that is not the side bonded to the first layer.

29. The structure of claim 23 in which the third layer further comprises a skin layer bonded to the side of the third layer that is not the side that is bonded to the first layer.

30. The structure of claim 29 in which the second layer comprises a skin layer bonded to the side of the second layer that is not the side that is bonded to the first layer.

31. The structure of claim 23 in which the high aspect ratio filler particles have a median particle size in their smallest dimension of between 2 and 15 microns.

32. The structure of claim 23 in which the low aspect ratio filler particles have a median particle size in their smallest dimension of between 0.5 and 2 microns.

33. A process for protecting an oxygen or moisture sensitive material comprising the steps of providing an oxygen or moisture sensitive material, enclosing the material in a container, wherein the container comprises a structure according to any of the sheet structure or the multilayer sheet structure claimed above.

34. A process for protecting an oxygen or moisture sensitive material comprising the steps of providing an oxygen or moisture sensitive material, enclosing the material in a container, wherein the container walls, lid or both are partially or totally constructed of a structure according to any of the sheet structure or the multilayer sheet structure claimed above.
